(19) United States
(12) Patent Application Publication
(10) Pub. No.: US 2025/0344875 A1
(43) Pub. Date: Nov. 13, 2025

(54) AIRBAG ASSEMBLY, MATTRESS AND BED

(71) Applicant: GREE ELECTRIC APPLIANCES, INC. OF ZHUHAI, Zhuhai City (CN)

(72) Inventors: Chao XU, Zhuhai City (CN); Yingjiang MA, Zhuhai City (CN); Shicai LONG, Zhuhai City (CN); Yi ZHANG, Zhuhai City (CN); Ming XIE, Zhuhai City (CN); Bowen QIU, Zhuhai City (CN)

(21) Appl. No.: 18/718,121

(22) PCT Filed: Jul. 26, 2022
(86) PCT No.: PCT/CN2022/107991

§ 371 Date: Dec. 2, 2024

(30) Foreign Application Priority Data
Dec. 17, 2021 (CN) 202111554976.X

(51) Int. Cl. A47C 27/10; A47C 27/08

(52) U.S. Cl. CPC A47C 27/10; A47C 27/087

(57) ABSTRACT

An airbag assembly (100), a mattress and a bed are provided, wherein the airbag assembly (100) includes a plurality of airbags (10), each airbag (10) including a plurality of stacked sub-airbags (12, 13) and at least one connecting part (11), and the at least one connecting part (11) being arranged between the adjacent sub-airbags (12, 13) of the plurality of sub-airbags, so as to communicate the sub-airbags (12, 13). When the airbag assembly (100) is horizontally placed, projections of the adjacent airbags (10) of the plurality of sub-airbags on a vertical plane are provided with an overlap portion; the airbag assembly (100) extends in a direction from first sides of the airbags (10) to second sides of the airbags (10); and sub-airbags (12, 13) at a top of one airbag (10) are connected with sub-airbags (12, 13) of the adjacent airbag (10). According to the above technical solution, the problems of poor integrity, stability and consistency of the airbag assembly (100) in related technologies are effectively solved.

### CROSS-REFERENCE TO RELATED APPLICATION

The present disclosure is a national stage application of International Patent Application No. PCT/CN2022/107991, which is filed on Jul. 26, 2022, and claims priority to Chinese Patent Application No. 202111554976.X, filed to the China National Intellectual Property Administration on Dec. 17, 2021 and entitled “Airbag Assembly, Mattress and Bed”, the disclosure of which is hereby incorporated by reference in its entirety.

### TECHNICAL FIELD

The present disclosure relates to the technical field of beds, and in particular to an airbag assembly, a mattress and a bed.

### BACKGROUND

With an improvement of people's living standards and a development of network technology, a concept of smart home has become more mature, including various household appliances or smart home products such as air conditioners, refrigerators, televisions, mobile phones, rice cookers and smart gateways. These smart home products are all provided with WiFi modules, temperature and humidity sensors, etc., which constitute an overall ecological environment of the smart home.

As the most core component of furniture, a bed is also gradually developing and evolving towards intelligence. Modules such as smart Bluetooth modules and speakers are integrated into a smart bed. One of the hotspot functions of a current smart bed is an attachment of an airbag assembly to achieve different functions.

In related technologies, airbags of the airbag assembly on the smart bed are arranged separately, and the airbags are spaced apart and do not affect each other, so that the airbag assembly has certain problems with the overall integrity, stability and consistency, the body feeling is poor, and even a problem of misalignment occurs.

### SUMMARY

The present disclosure provides an airbag assembly, a mattress and a bed so as to solve the problems of poor integrity, stability and consistency of the airbag assembly in related technologies.

In a first aspect, the present disclosure provides an airbag assembly, including a plurality of airbags, each airbag including a plurality of stacked sub-airbags and at least one connecting part, and the at least one connecting part being arranged between adjacent sub-airbags of the plurality of sub-airbags, so as to communicate the sub-airbags. When the airbag assembly is horizontally placed, projections of the adjacent airbags of the plurality of sub-airbags on a vertical plane are provided with an overlap portion. The airbag assembly extends in a direction from first sides of the airbags to second sides of the airbags. Sub-airbags at a top of one airbag in the plurality of airbags is connected with sub-airbags of an adjacent airbag in the plurality of airbags.

In some implementations, the plurality of sub-airbags include a first sub-airbag and a second sub-airbag, the at least one connecting part being arranged between the first sub-airbag and the second sub-airbag, and a first side of a latter airbag of the plurality of airbags being clamped between a first sub-airbag and a second sub-airbag of a former airbag of the plurality of airbags.

In some implementations, a second sub-airbag of the latter airbag is connected with the former second sub-airbag of the former airbag.

In some implementations, in the airbags, adjacent second sub-airbags are fixedly connected and/or the adjacent second sub-airbags are able to be relatively movably connected through connecting pieces.

In some implementations, in the airbags, adjacent second sub-airbags are able to be relatively movably connected, connection manners between the adjacent second sub-airbags include a ribbon connection, a rivet connection and a rope bundling connection.

In some implementations, each second sub-airbag is provided with at least one connecting through hole, and the connecting pieces pass through the at least one connecting through hole.

In some implementations, the at least one connecting through hole is located on a second side of the each second sub-airbag.

In some implementations, a plurality of connecting through holes are arranged on the each second sub-airbag, and the plurality of connecting through holes are arranged on both sides in the direction from the first sides of the airbags to the second sides of the airbags.

In some implementations, each second sub-airbag is further provided with at least one matching through hole, and the connecting pieces pass through the at least one connecting through holes and the at least one matching through hole so as to connect the second sub-airbags.

In some implementations, a plurality of matching through holes are arranged, and the plurality of matching through holes are respectively located between the first sides of the airbags and the second sides of the airbags, and are located on both sides in an extension direction from the first sides of the airbags to the second sides of the airbags.

In some implementations, the plurality of matching through holes are arranged on each side.

In some implementations, each of the connecting through holes and/or each of the matching through holes are slotted holes extending in the direction from the first sides of the airbags to the second sides of the airbags.

In some implementations, when the rivet connection is used, a length of a polished rod of a rivet is greater than a sum of a wall thicknesses of two second sub-airbags.

In some implementations, when the adjacent second sub-airbags are fixedly connected, connection manners between the adjacent second sub-airbags include an adhesive bonding, a sewing connection, a fastener connection and a hook-and-loop fastener connection.

In a second aspect, the present disclosure provides a mattress, including the above airbag assembly.

In a third aspect, the present disclosure provides a bed, including the above mattress.

Compared with the related technologies, the technical solution provided by the embodiments of the present disclosure has the following advantages.

In the technical solution of the present disclosure, each airbag of the airbag assembly is composed of the plurality of stacked sub-airbags, so that a working height of the airbag may be raised without increasing a diameter of the airbag, and a structure well meets the requirement of a human body for the pushing and stroking height. The sub-airbag at the top of one airbag is connected with the sub-airbag of the adjacent airbag, so that the sub-airbag at the top of one airbag is not prone to misalignment, thereby providing better integrity, stability and consistency for the pushing and stroking feeling of the human body. The technical solution of the present disclosure effectively solves the problems of poor integrity, stability and consistency of the airbag assembly in the related technologies.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to more clearly illustrate the embodiments of the present disclosure or the technical solutions in related technologies, the accompanying drawings used in the description of the embodiments or the related technologies will be briefly described below. It is apparent that other accompanying drawings may further be obtained by those of ordinary skill in the art according to these accompanying drawings without creative efforts.

FIG. 1 shows a schematic diagram of a three-dimensional structure of an airbag of an airbag assembly according to an embodiment of the present disclosure.

FIG. 2 shows a schematic main view of an airbag in FIG. 1.

FIG. 3 shows a schematic structural diagram of an airbag in FIG. 2 from another angle.

FIG. 4 shows a schematic diagram of a three-dimensional structure of an airbag assembly in FIG. 1.

FIG. 5 shows a schematic structural diagram of a connection between an airbag and a mattress body according to an embodiment of the present disclosure.

FIG. 6 shows a schematic diagram of a matching structure of a mattress according to an embodiment in FIG. 1 and a human body.

Herein, the above accompanying drawings include the following reference signs.

10. Airbag; 11. Connecting part; 12. First sub-airbag; 13. Second sub-airbag; 131. Connecting through hole; 132. Matching through hole; 100. Airbag assembly.

### DETAILED DESCRIPTION OF THE EMBODIMENTS

In order to make the objects, technical solutions and advantages of the embodiments of the present disclosure clearer, the technical solutions in the embodiments of the present disclosure will be clearly and completely described in conjunction with the accompanying drawings in the embodiments of the present disclosure. It is apparent that the described embodiment are only a part of the embodiments of the present disclosure, and not all of them. All other embodiments obtained by those of ordinary skill in the art on the basis of the embodiments in the present disclosure without creative work shall fall within the scope of protection of the present disclosure.

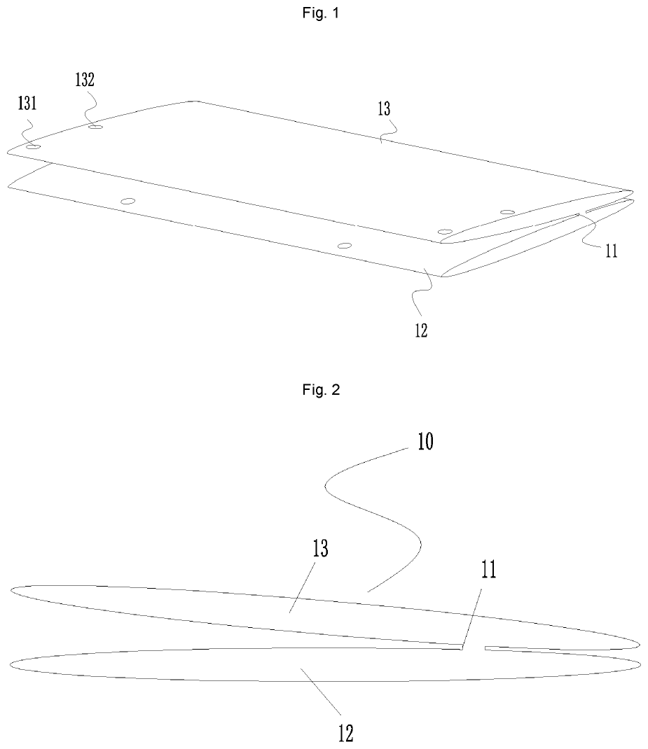

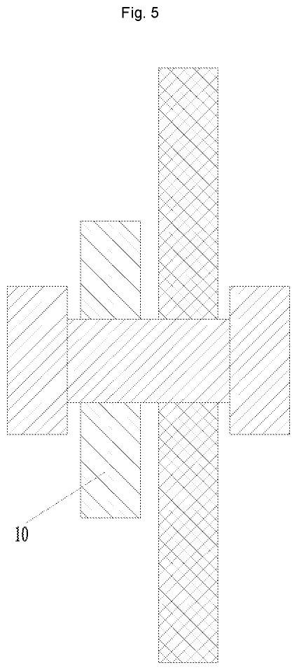

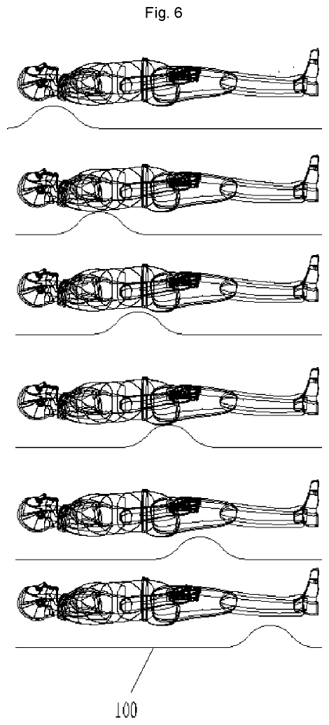

As shown in FIG. 1 to FIG. 6, an airbag assembly in the embodiment includes a plurality of airbags 10, each airbag 10 including a plurality of stacked sub-airbags and at least one connecting part 11, and the at least one connecting part 11 being arranged between adjacent sub-airbags of the plurality of sub-airbags, so as to communicate the sub-airbags. When the airbag assembly is horizontally placed, projections of adjacent airbags 10 of the plurality of sub-airbags on a vertical plane are provided with an overlap portion. The airbag assembly 100 extends in a direction from first sides of the airbags 10 to second sides of the airbags 10. Sub-airbags at a top of one airbag 10 in the plurality of airbags is connected with sub-airbags of an adjacent airbag 10 in the plurality of airbags.

In the technical solution of the present disclosure, each airbag 10 of the airbag assembly 100 is composed of the plurality of stacked sub-airbags, so that a working height of the airbag may be raised without increasing a diameter of the airbag, and a structure well meets the requirement of a human body for the pushing and stroking height. The sub-airbag at the top of one airbag is connected with the sub-airbag of the adjacent airbag, so that the sub-airbag at the top of one airbag is not prone to misalignment, thereby providing better integrity, stability and consistency for the pushing and stroking feeling of the human body. The technical solution of the embodiment effectively solves the problems of poor integrity, stability and consistency of the airbag assembly in the related technologies.

It is to be noted that the connecting part 11 in the embodiment has a predetermined length, which facilitates the arrangement of an airbag clamping structure. The sub-airbags in the airbag are bonded together or integrally formed, rather than simply placing the airbag at an upper part on the airbag at a lower part. A bottom surface of a first sub-airbag 12 at a bottom of the airbag is provided with at least one airbag connecting piece, the at least one airbag connecting piece is flat, and the at least one airbag connecting piece extends in an extension direction of the airbag assembly, as appropriate. Through a flat structure, the at least one airbag connecting piece does not cause discomfort to the body feeling of the human body in a thickness. If the at least one airbag connecting piece is thicker, grooves may be arranged in the mattress to adapt to the at least one airbag connecting piece. In the technical solution of the embodiment, a plurality of airbag connecting pieces are arranged at intervals, and each airbag connecting piece extends in the extension direction of the airbag assembly. In this way, the airbag assembly 100 is firmer in structure and better in consistency, and the airbag is not prone to disengagement. As other implementations, each airbag connecting piece is a closed rectangle, so that the airbag assembly 100 of this structure has better integrity, and the airbag assembly 100 is firmer through the structure. Or each airbag connecting piece is a rectangle with a hollow structure, so that the airbag assembly 100 of the structure is more material-saving and lighter in weight. It is to be noted that the hollow structure may be in various forms, such as a large rectangle hollow in the middle, so that the airbag connecting piece is square. The airbag connecting pieces are located on the same side of the airbag assembly 100, which facilitates the matching of the airbag assembly 100 with a mattress body. For example, the airbag connecting pieces are located at a bottom of the airbag assembly 100. When the airbag assembly 100 is installed, an installation may be completed through the side of the airbag assembly 100. The airbag 10 is connected with the airbag connecting pieces in various manners: the airbag 10 is bonded and connected with the airbag connecting pieces; or the airbag 10 is bundled and connected with the airbag connecting pieces through a ribbon; or the airbag 10 is bundled and connected with the airbag connecting pieces through a flexible rope; or the airbag 10 is welded and connected with the airbag connecting pieces; or the airbag 10 is connected with the airbag connecting pieces through a zipper; or a combination of the above connection manners is also possible. It is to be noted that it is also possible for the airbag assembly 100 to be riveted directly to the mattress body, as shown in FIG. 5.

As shown in FIG. 1 to FIG. 4, the plurality of sub-airbags include a first sub-airbag 12 and a second sub-airbag 13, the at least one connecting part 11 being arranged between the first sub-airbag 12 and the second sub-airbag 13, and a first side of a latter airbag of the plurality of airbags being clamped between a first sub-airbag 12 and a second sub-airbag 13 of a former airbag of the plurality of airbags. Through a structure that the first side of the latter airbag is clamped between the first sub-airbag 12 and the second sub-airbag 13 of the former airbag, each airbag 10 of the airbag assembly 100 is not prone to disengagement, that is, part of an upper surface of the latter airbag 10 is attached to a lower surface of the second sub-airbag 13 of the former airbag, and part of a lower surface of the latter airbag 10 is attached to an upper surface of the first sub-airbag 12 of the former airbag. The sub-airbags of the same airbag 10 communicate with each other. The structure is convenient to inflate, and does not need to inflate each sub-airbag separately. Moreover, the arrangement of more inflation ports may be avoided and the probability of damage is reduced. The inflation port of the airbag 10 is arranged on a side, far away from the second sub-airbag 13, of the first sub-airbag 12. When the airbag 10 is not inflated, the first sub-airbag 12 and the second sub-airbag 13 overlap into a rectangle.

In the technical solution of the embodiment, ta second sub-airbag 13 of the latter airbag is connected with the former second sub-airbag 13 of the former airbag. In this way, the airbag assembly 100 is not prone to disengagement when subjected to external forces.

In the technical solution of the embodiment, in the airbags 10, adjacent second sub-airbags 13 are fixedly connected, and/or the adjacent second sub-airbags 13 may be relatively movably connected through at least one connecting piece. In actual use, the adjacent second sub-airbags 13 may be fixedly connected, or the adjacent second sub-airbags 13 may be relatively movably connected through the at least one connecting pieces, or the adjacent second sub-airbags 13 are fixedly connected and the adjacent second sub-airbags 13 are relatively movably connected through the connecting pieces in the same airbag assembly 100.

In the technical solution of the embodiment, when the adjacent second sub-airbags 13 may be relatively movably connected, the connection manners between the adjacent second sub-airbags 13 include a ribbon connection, a rivet connection and a rope bundling connection. Because the airbag assembly 100 has an inflation state and a non-inflation state, the relative position between the two sub-airbags may change, and the adjacent second sub-airbags 13 may be relatively movably connected to exactly meet a state of a change in the relative position.

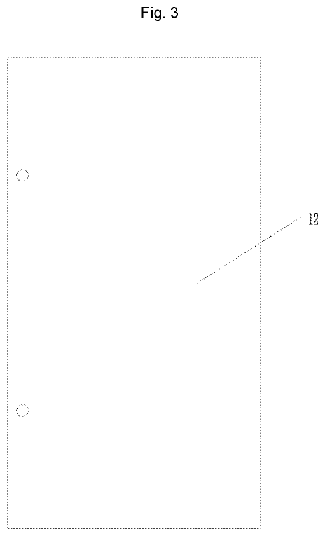

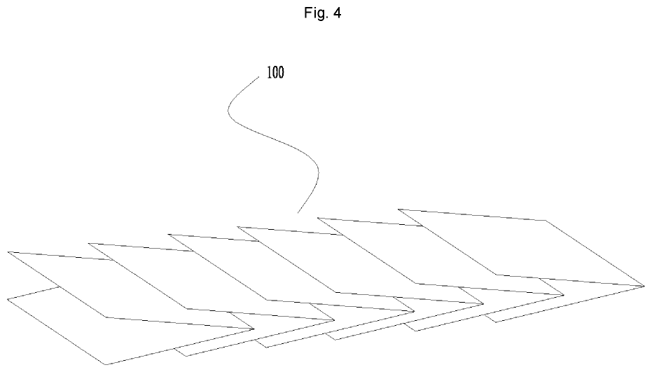

As shown in FIG. 1 and FIG. 3, in the technical solution of the embodiment, each second sub-airbag 13 is provided with at least one connecting through hole 131, and the at least one connecting piece pass through the at least one connecting through hole 131. The at least one connecting through hole 131 are arranged, so that the connection is convenient, the operation is simple, and the arrangement cost is low. It is to be noted that each sub-airbag in the embodiment includes a sub-airbag body and a skirt located at an edge of each sub-airbag, and the at least one connecting through hole 131 is arranged at the skirt, so that each sub-airbag cannot be damaged.

As shown in FIG. 1, in the technical solution of the embodiment, the at least one connecting through hole 131 is located on a second side of the each second sub-airbag 13. The at least one connecting through hole 131 is located on the skirt of the second side of the second sub-airbag 13, which facilitates the connection of the second sub-airbag 13.

As shown in FIG. 1, in the technical solution of the embodiment, a plurality of connecting through holes 131 are arranged on each second sub-airbag 13, and the plurality of connecting through holes 131 are arranged on both sides in the direction from the first side of the airbag 10 to the second side of the airbag 10. The structure facilitates the connection between the adjacent second sub-airbags 13, so that a stress of the airbag 10 is balanced. The plurality of connecting through holes 131 are located on both sides in the extension direction of the airbag assembly 100, so that the connecting through holes 131 are located on the side of the second sub-airbag 13, and the structure prevents the airbag 10 from being lifted, misaligned, etc., from the edge.

As shown in FIG. 1, in the technical solution of the embodiment, each second sub-airbag 13 is further provided with at least one matching through hole 132, and the at least one connecting piece passes through the at least one connecting through hole 131 and the at least one matching through hole 132 so as to connect the second sub-airbags 13. Through the matching form of the at least one connecting through hole 131 and the at least one matching through hole 132, the connection between the second sub-airbags becomes more convenient.

As shown in FIG. 1, in the technical solution of the embodiment, a plurality of matching through holes 132 are arranged, and the plurality of matching through holes 132 are respectively located between the first sides of the airbags 10 and the second sides of the airbags 10, and are located on both sides in an extension direction from the first sides of the airbags 10 to the second sides of the airbags 10. In this way, the matching between the matching through holes 132 and the connecting through holes 131 is more convenient, and the matching through holes 132 and the connecting through holes 131 may not damage the airbag body.

In the technical solutions of the present disclosure, the plurality of matching through holes 132 are arranged on each side. In this way, the connection positions of the two adjacent second sub-airbags 13 may be adjusted as required, so that the adjacent airbags 10 are in an optimal matching state.

In the technical solution of the embodiment (not shown in the figures), when the rivet connection is used, the connecting through holes 131 are slotted holes extending in the direction from the first sides of the airbags 10 to the second sides of the airbags 10. The connecting through holes 131 are the slotted holes extending in the direction from the first sides of the airbags 10 to the second sides of the airbags 10, so that the adjacent second sub-airbags 13 may relatively move in the direction from the first sides of the airbags 10 to the second sides of the airbags 10, and form a limitation in other directions. It is to be noted that when the rivet connection is used, the length of a polished rod of a rivet is greater than a sum of wall thicknesses of the two second adjacent sub-airbags, and a width of the slotted hole is adapted to a diameter of the rivet, so that the second sub-airbags 13 cannot move in a left-right direction, but can be relatively unique in a front-back direction. The rivet in the embodiment may be made of a metal material or a non-metal material such as a rubber or a silica gel. As other implementations, the matching through holes 132 may also be the slotted holes, and the connecting through holes 131 and the matching through holes 132 may also be the slotted holes.

As other implementations, the adjacent second sub-airbags 13 may also be fixedly connected. The fixed connection manners include, but are not limited to, the following connection manners: an adhesive bonding, a sewing connection, a fastener connection and a hook-and-loop fastener connection.

The adjacent airbags are matched in a clamped and overlapping manner.

In the technical solution of the embodiment, a side surface, far away from the first sub-airbag 12, of the second sub-airbag 13 is provided with a curved surface. A smooth curved transition manner is used, which makes the body feeling of the human body better. Specifically, the second sub-airbag 13 is gradually contracted and thinned from a certain position in the middle to the first side of the second sub-airbag 13, and the second sub-airbag 13 is gradually contracted and thinned from a certain corresponding position in the middle of the second sub-airbag 13 to the second side of the second sub-airbag 13. A projected area of the first sub-airbag 12 in a vertical direction is equal to a projected area of the second sub-airbag 13 in the vertical direction. An area of the first sub-airbag 12 is the same as that of the second sub-airbag 13, so that the structure has stronger adaptability and generally meets the requirements for the stability and pushing and stroking. As other implementations that may be implemented, the projected area of the first sub-airbag 12 in the vertical direction is greater than the projected area of the second sub-airbag 13 in the vertical direction, that is, the area of the sub-airbag at the lower part is larger, so that the airbag is more stable. That is, the first sub-airbag 12 is arranged to be larger than the second sub-airbag 13, so that the bottom support of the airbag is stable, and at this time, the airbag at the top is smaller, which may give a larger pressure to the human body to experience greater pushing and stroking strength. Other implementations may also be as follows: the projected area of the first sub-airbag 12 in the vertical direction is smaller than the projected area of the second sub-airbag 13 in the vertical direction, the structure makes the pushing and stroking area of the airbag larger. The first sub-airbag 12 is arranged to be smaller than the second sub-airbag 13, so that the airbag at the bottom may form a structure similar to a seesaw. At this time, when the human body lies down above the airbag, the airbag may move in the same direction according to an adjustment of the position of the human body.

As shown in FIG. 1, in the technical solution of the embodiment, a length of the connecting part 11 to the first side of the airbag 10 accounts for ⅛ to ½ of a length from the first side of the airbag 10 to the second side of the airbag 10. The airbags 10 are more stably matched when combined, for example, when the airbags 10 are clamped, the matching area is larger. Specifically, a length of the connecting part 11 to the second side of the airbag 10 accounts for ¼ to ⅓ of the length from the first side of the airbag 10 to the second side of the airbag 10.

As shown in FIG. 1, in the technical solution of the embodiment, the connecting part 11 is one or more connecting pipelines. The arrangement of the structure is convenient, the connecting part 11, the first sub-airbag 12 and the second sub-airbag 13 are made of the same material, and are of an integrally formed structure in the embodiment. Of course, the connecting part 11, the first sub-airbag 12 and the second sub-airbag 13 may also be made of different materials, and even in different colors for distinguishing, and functional areas are distinguished by colors. In the technical solution of the embodiment, the first sub-airbag 12, the second sub-airbag 13 and the connecting part 11 may be made of a Thermoplastic Polyurethane (TPU) material, a rubber material, etc. When the connecting part 11 is one connecting pipeline, a distance between the connecting pipeline and a left side of the airbag is equal to a distance between the connecting pipeline and a right side of the airbag. The above structure makes the stress of the airbag 10 more uniform. The arrangement manner of one pipeline may be as follows: the connecting pipeline is from the left side of the airbag to the right side of the airbag. The structure makes the structure of the connecting pipeline firmer, the airbag may withstand a larger force, the stress is more uniform, and the connecting pipeline is not prone to congestion. For example, when the human body is pressed above the airbag 10, the connecting pipeline is easily blocked due to the action of pressure, and a larger gas pressure is required. Of course, the arrangement manner of one pipeline may be as follows: the distance between the connecting pipeline and the left side of the airbag is equal to the distance between the connecting pipeline and the right side of the airbag, so as to balance the stress of the airbag. It is to be noted that when the distance between the connecting pipeline and the left side of the airbag and the distance between the connecting pipeline and the right side of the airbag are larger, a gap at the edge may be larger, and the comfort may be reduced. The shape of the pipeline is similar to a rectangle. The first sub-airbag 12 and the second sub-airbag 13 are also in a shape like a rectangle when no gas exists. When the connecting parts 11 are the plurality of connecting pipelines, the connecting pipelines are uniformly arranged at intervals in the direction from the left side of the airbag to the right side of the airbag. The stress of the airbag 10 of the above structure is more uniform.

The present disclosure further provides a mattress, including an airbag assembly 100. The airbag assembly 100 is the above airbag assembly 100. The mattress is more coherent in pushing and stroking, better in integrity and better in stability. Specifically, the mattress includes a mattress body, connected with the airbag assembly 100.

The present disclosure further provides a bed, including a mattress. The mattress is the above mattress. The bed in the present disclosure has better coherence in pushing and stroking, stability and integrity.

It is to be noted that relational terms “first”, “second” and the like herein are adopted only to distinguish one entity or operation from another entity or operation and not always to require or imply existence of any such practical relationship or sequence between the entities or operations. Furthermore, terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . ” does not exclude existence of the same other elements in a process, method, object or device including the element.

The above is only the specific implementation of the present disclosure, which causes those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but is within the widest scope consistent with the principles and novel features applied herein.

What is claimed is:

1. An airbag assembly, comprising:
a plurality of airbags (10), each airbag (10) comprising a plurality of stacked sub-airbags and at least one connecting part (11), and the at least one connecting part (11) being arranged between adjacent sub-airbags of the plurality of sub-airbags, so as to communicate the sub-airbags; when the airbag assembly is horizontally placed, projections of the adjacent airbags (10) of the plurality of sub-airbags on a vertical plane are provided with an overlap portion; the airbag assembly extends in a direction from first sides of the airbags (10) to second sides of the airbags (10); and sub-airbags at a top of one airbag (10) in the plurality of airbags are connected with sub-airbags of an adjacent airbag (10) in the plurality of airbags.

2. The airbag assembly according to claim 1, wherein the plurality of sub-airbags comprise a first sub-airbag (12) and a second sub-airbag (13), the at least one connecting part (11) being arranged between the first sub-airbag (12) and the second sub-airbag (13), and a first side of a latter airbag of the plurality of airbags being clamped between a first sub-airbag (12) and a second sub-airbag (13) of a former airbag of the plurality of airbags.

3. The airbag assembly according to claim 2, wherein a second sub-airbag (13) of the latter airbag is connected with the second sub-airbag (13) of the former airbag.

4. The airbag assembly according to claim 3, wherein in the airbags (10) adjacent second sub-airbags (13) are fixedly connected.

5. The airbag assembly according to claim 3, wherein in the airbags (10), adjacent second sub-airbags (13) are able to be relatively movably connected through at least one connecting piece.

6. The airbag assembly according to claim 5, wherein connection manners between the adjacent second sub-airbags (13) comprise a ribbon connection, a rivet connection and a rope bundling connection

7. The airbag assembly according to claim 6, wherein each second sub-airbag (13) is provided with at least one connecting through hole (131), and the at least one connecting piece passes through the at least one connecting through hole (131).

8. The airbag assembly according to claim 7, wherein the at least one connecting through hole (131) is located on a second side of the each second sub-airbag (13).

9. The airbag assembly according to claim 8, wherein a plurality of connecting through holes (131) are arranged on the each second sub-airbag (13), and the plurality of connecting through holes (131) are arranged on both sides in the direction from the first sides of the airbags (10) to the second sides of the airbags (10).

10. The airbag assembly according to claim 7, wherein each second sub-airbag (13) is further provided with at least one matching through hole (132), and the at least one connecting piece passes through the at least one connecting through hole (131) and the at least one matching through hole (132) so as to connect the second sub-airbags (13).

11. The airbag assembly according to claim 10, wherein a plurality of matching through holes (132) are arranged, and the plurality of matching through holes (132) are respectively located between the first sides of the airbags (10) and the second sides of the airbags (10), and are located on both sides in an extension direction from the first sides of the airbags (10) to the second sides of the airbags (10).

12. The airbag assembly according to claim 11, wherein the plurality of matching through holes (132) are arranged on each side.

13. The airbag assembly according to claim 10 or 11, wherein the connecting through holes (131) or the matching through holes (132) are slotted holes extending in the direction from the first sides of the airbags (10) to the second sides of the airbags (10).

14. The airbag assembly according to claim 10 or 11, wherein the connecting through holes (131) and the matching through holes (121) are slotted holes extending in the direction from the first sides of the airbags (10) to the second sides of the airbags (10).

15. The airbag assembly according to claim 13, wherein, when the rivet connection is used, a length of a polished rod of a rivet is greater than a sum of wall thicknesses of two adjacent second sub-airbags (13).

16. The airbag assembly according to claim 4, wherein connection manners between the adjacent second sub-airbags (13) comprise an adhesive bonding, a sewing connection, a fastener connection and a hook-and-loop fastener connection.

17. A mattress, comprising the airbag assembly (100) according to any one of claims 1 to 16.

18. A bed, comprising the mattress according to claim 17.
